(19) United States
(12) Patent Application Publication
(10) Pub. No.: US 2005/0288044 A1
(43) Pub. Date: Dec. 29, 2005

(54) System and method for using soap to invoke web services on handheld devices

(75) Inventors: Barry D. Atkins, Raleigh, NC (US); Bryce A. Curtis, Round Rock, TX (US); Peter F. Haggar, Raleigh, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/878,297

(22) Filed: Jun. 28, 2004

(51) Int. Cl. H04Q 7/20

(52) U.S. Cl. 455/466

(57) ABSTRACT

A method, computer program product, and apparatus for invoking web services on handheld or mobile devices is disclosed. In one embodiment, Mobile Data Service is used to push a SOAP envelope to a handheld device in the form of a message. In another embodiment, a requesting application server generates a key in addition to the SOAP envelope for the request. The handheld device is sent a message via Short Message Service (SMS) containing the key, and the mobile device uses the key to retrieve or “pull” the SOAP envelope for the request. In yet another embodiment, SOAP envelopes are transmitted as raw data to a handheld device on a particular designated TCP (Transmission Control Protocol) port. In this case, the handheld device recognizes that it has received a SOAP envelope by virtue of the fact that the data was received on the designated port.

### BACKGROUND OF THE INVENTION

1. Technical Field

The present invention relates to communication with handheld computing devices. Specifically, the present invention is directed to a system and method for invoking web services on a handheld device.

2. Background Art

Since the introduction of the World Wide Web and the subsequent commercialization of the Internet, the world has become a considerably more connected place. No longer bound to the primitive communications interfaces of the past, the Internet is now host to a variety of powerful communications media, including interactive hypertext browsing (the World Wide Web), instant messaging, streaming video and audio, and multimedia electronic mail.

The largest and best-known repository of information on the Internet is the World Wide Web, a loosely bound collection of publicly accessible hypertext documents stored on computers the world over. The World Wide Web has become the preferred Internet medium for publishable information as well as for providing such interactive features as online shopping-to the extent that the terms Internet and World Wide Web are virtually synonymous to some. Resources on the World Wide Web are addressed by URL (Uniform Resource Locator).

Browsers can download hypertext documents from a server with the HyperText Transfer Protocol (HTTP) HTTP allows a browser to request documents or files from a server, in accordance with the documents' or files' URLs, and receive a response. In addition, when browser users enter information into a form embedded into a hypertext page, the browser transmits the information to a server using HTTP. Form information can then be passed along to applications residing on the server by way of the Common Gateway Interface (CGI) or through other mechanisms, such as server-side script languages like PHP. Those applications can then return a result, which may be written in HTML. The interactive nature of the World Wide Web has made it increasingly commonplace to conduct business and legal transactions over the Internet.

The popularity of conducting transactions over the Web has led to an increasing demand for businesses to integrate their Internet applications with Internet applications of other businesses. However, these Internet applications are often implemented using proprietary software written in differing programming languages and having proprietary formats for representing data.

Standardized “web services” represent one significant solution to this problem. Strictly speaking, a web service is a URL-accessible resource that returns information in response to client requests. As the term is most commonly used, however, a web service is an application that accepts remote procedure calls (RPCs) through a protocol in which information is encoded in an XML-based format. XML stands for extensible Markup Language. XML is a standard for representing data in a hierarchical format based on markup tags. One popular XML-based web services protocol is the Simple Object Access Protocol (SOAP).

SOAP is a protocol for exchange of information in a decentralized, distributed environment and consists of three parts: (i) an envelope that defines a framework for describing what is in a message and how to process it; (ii) a set of encoding rules for expressing instances of application-defined data types; and (iii) a convention for representing remote procedure calls and responses. To access our web service, a client transmits a SOAP envelope in an HTTP request. The web service sends a SOAP reply over the same HTTP connection.

Since web services protocols such as SOAP are intended to operate on top of HTTP, web services typically must rely on an HTTP server (generally a web server or application server) to handle the transport of SOAP requests and replies. While this is generally not a problem for larger-scale computer systems, such as a dedicated web server, the computing resources (memory, disk space, etc.) required to support a typical HTTP server far exceed the capabilities of smaller mobile and handheld devices. Nonetheless, it would be advantageous to allow a small-scale computing device to support web services, since it would allow advanced business systems to adopt a “push” model of information transmission. The present invention provides a solution to this and other problems, and offers other advantages over previous solutions.

### SUMMARY OF THE INVENTION

A preferred embodiment of the present invention provides a method, computer program product, and data processing system for invoking web services on handheld or mobile devices. Because handheld devices have a limited amount of computing resources, they are not suitable for hosting the large HTTP (HyperText Transfer Protocol) servers usually utilized for providing web services. Preferred embodiments of the present invention utilize various strategies to allow web services to be invoked on a handheld device using SOAP (Simple Object Access Protocol) in the absence of an HTTP server. In one embodiment, Mobile Data Service (used by handheld computing devices manufactured by Research In Motion, Inc., or “RIM”) is used to push a SOAP envelope to a handheld device in the form of an MDS (Mobile Data Service) message. In another embodiment, a requesting application server generates a key in addition to the SOAP envelope for the request. The mobile device is sent a message via Short Message Service (SMS) containing the key, and the mobile device uses the key to retrieve or “pull” the SOAP envelope for the request. In yet another embodiment, SOAP envelopes are transmitted as raw data to a handheld device on a particular designated TCP (Transmission Control Protocol) port. In this case, the handheld device recognizes that it has received a SOAP envelope by virtue of the fact that the data was received on the designated port.

These and various other features and advantages that characterize the present invention will be apparent upon reading of the following detailed description and review of the associated drawings.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram illustrating the operation of a preferred embodiment of the present invention in which web services residing on a mobile handheld computing/communications device are invoked by an application server using Mobile Data Service (MDS);

FIG. 2 is a diagram illustrating the operation of a preferred embodiment of the present invention in which web services residing on a mobile handheld computing/communications device supporting the GSM telecommunications standard are invoked by an application server using Small Message Service (SMS) messages;

FIG. 3 is a diagram illustrating the operation of a preferred embodiment of the present invention in which web services residing on a mobile handheld computing/communications device in a wireless local area network (WLAN) are invoked by an application server;

FIG. 4 is a flowchart representation of a process of invoking web services on a handheld device using Mobile Data Service (MDS) in accordance with a preferred embodiment of the present invention;

FIG. 5 is a flowchart representation of a process of invoking web services on a handheld device using the Short Message Service (SMS) of GSM (Global System for Mobile Communications) in accordance with a preferred embodiment of the present invention;

FIG. 6 is a flowchart representation of a process of invoking web services on a handheld device connected to a wireless LAN (WLAN)., such as an IEEE 802.11 wireless network, in accordance with a preferred embodiment of the present invention;

FIG. 7 is a block diagram of a personal digital assistant in accordance with a preferred embodiment of the present invention; and

FIG. 8 is a block diagram of a computing device capable of supporting a preferred embodiment of the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

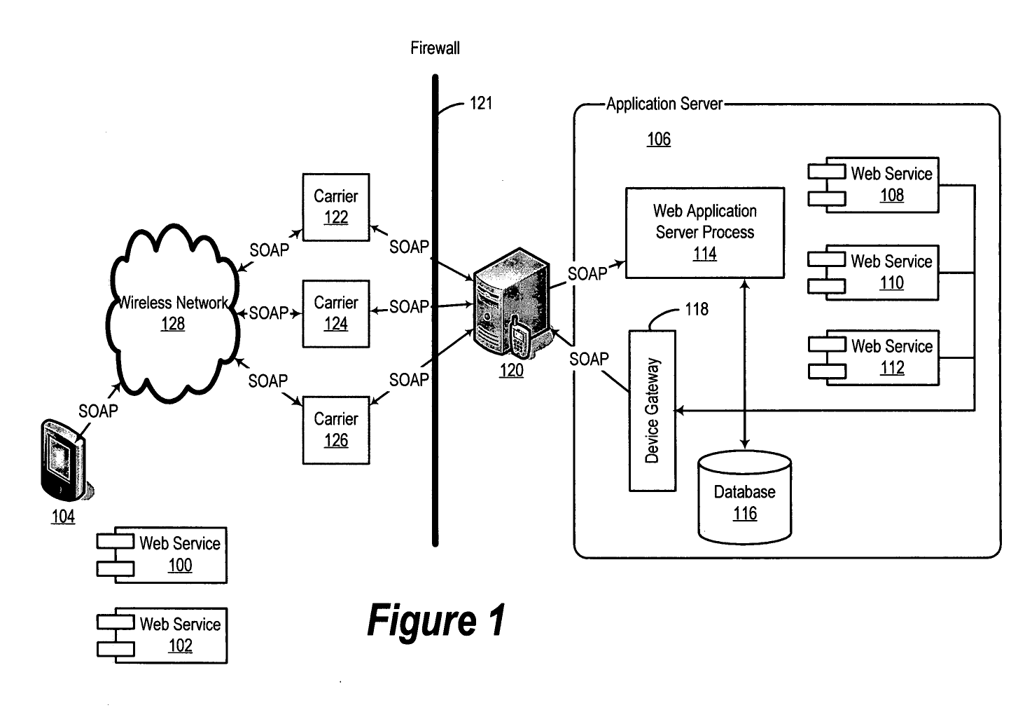

FIG. 1 is a diagram illustrating the operation of a preferred embodiment of the present invention in which web services (e.g., web services 100 and 102) residing on a mobile handheld computing/communications device 104 are invoked by an application server 106 using Mobile Data Service (MDS). MDS is a feature provided by a commercial product known as Blackberry Enterprise Server (BES), which is produced by Research In Motion, Inc. (RIM). MDS allows data (usually in the form of browsable text or hypertext) to be pushed to a Blackberry-compatible mobile electronic mail/Internet device. Unlike the World Wide Web's conventional pull model, where a client computer must request (pull) a page from a server, MDS's push capability allows BES to autonomously initiate a transmission of data to a handheld client.

In FIG. 1, a web application server process 114 (such as WebSphere, a product of International Business Machines Corporation) oversees the execution of various web services 108, 110, and 112, which reside on application server 106. Web application server process 114 may also be supported by a database management system 116, which may be a relational or object-relational database management system, such as DB2, a product of International Business Machines Corporation.

When one of web services 108, 110, and 112 needs to invoke a remote web service (such as web service 100) on handheld device 104, the invoking web service generates a request in a web services protocol to execute the remote web service. Some common web services protocol standards that may be employed for this purpose include SOAP (Simple Object Access Protocol) and XML-RPC (extensible Markup Language-Remote Procedure Call). Both of these protocols allow remote procedure calls to be requested (and the results returned) using an XML-based data format.

Device gateway 118 relays the web services request (typically in the form of a SOAP envelope) to Blackberry Enterprise Server (BES) 120, which transmits the request via MDS, through firewall 121, to one or more of a variety of possible wireless data carriers 122, 124, and 126 (such as a mobile telephone company). Carriers 122, 124, and 126 link the wired Internet, to which application server 106 is connected, with wireless network 128, which may be supported by any of a number of wireless data transmission protocols, standards, or encodings such as CDMA (Code Division Multiplexing), GSM (Global System for Mobile Communications), GPRS (General Packet Radio Service), or other wireless data communications standards. Blackberry-compatible devices are identified by a PIN (personal identification number) number, which, in the context of an embodiment of the present invention, is used to route web service requests to the appropriate user's handheld device.

Since MDS is commonly used to transmit electronic mail, in one embodiment of the invention, a SOAP envelope is transmitted as if it were electronic mail. Once the SOAP envelope is received by handheld device 104, however, handheld device 104 parses the received envelope, which indicates to handheld device 104 that the received MDS transmission is, in fact, a SOAP envelope. The SOAP envelope is then decoded, and one of web services 100 or 102 is then executed by handheld device 104. The result of the execution is then returned as a SOAP reply, through wireless network 128 and one or more of carriers 122, 124, and 126, to BES 120 which, in turn, relays the response to web application server process 114.

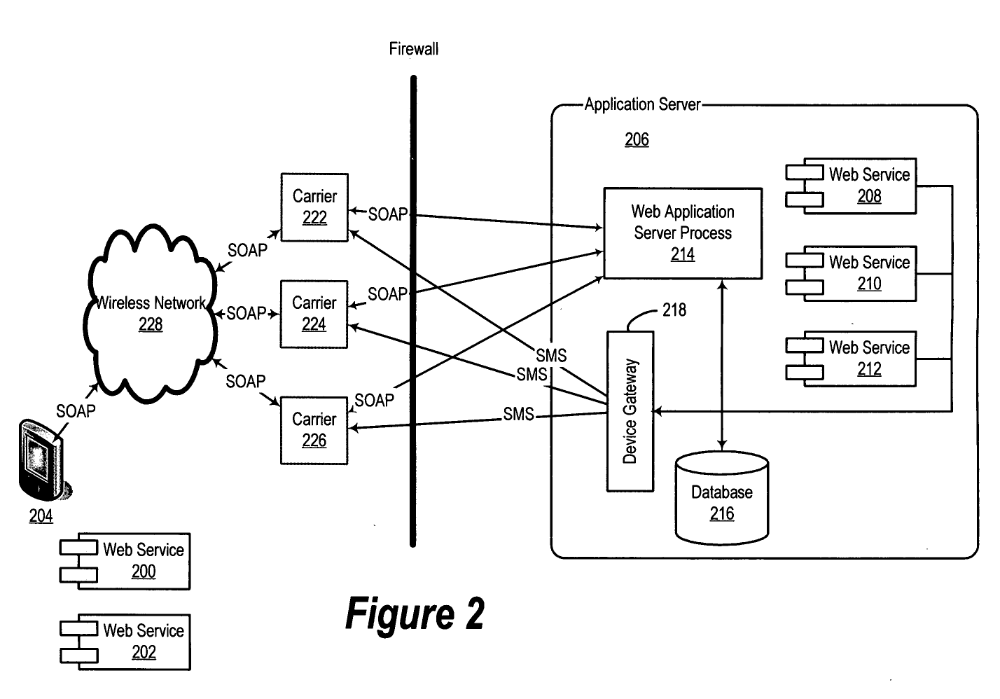

FIG. 2 is a diagram illustrating the operation of a preferred embodiment of the present invention in which web services (e.g., web services 200 and 202) residing on a mobile handheld computing/communications device 204 supporting the GSM telecommunications standard (such as a mobile telephone) are invoked by an application server 206 using Small Message Service (SMS) messages. SMS is a bidirectional service for short alphanumeric (up to 160 bytes) messages. Messages are transported in a store-and-forward fashion. For point-to-point SMS, a message can be sent to another subscriber to the service, and an acknowledgement of receipt is provided to the sender. SMS can also be used in a cell-broadcast mode, for sending messages such as traffic updates or news updates. Messages can also be stored in the handheld device for later retrieval. SMS messages are routed to GSM devices according to the telephone number assigned to the GSM device.

When one of web services 208, 210, and 212 needs to invoke a remote web service (such as web service 200) on handheld device 204, the invoking web service generates a request in a web services protocol (typically a SOAP envelope) to execute the remote web service. Web application server process 214 also generates a key that uniquely identifies the generated request. Since SMS only allows messages of up to 160 bytes to be pushed to a wireless device, SMS is impractical for directly pushing SOAP envelopes, which can easily exceed 160 bytes. Rather than sending the SOAP envelope in an SMS message, then, device gateway 218 sends, via SMS, a notification message that contains the key associated with the generated SOAP envelope. This SMS message is relayed through or more of GSM carriers 222, 224, and 226 over wireless network 228 to handheld device 204.

Handheld device 204, once it receives the SMS message, parses the received message and determines that the SMS message refers to a SOAP envelope on application server 206. Handheld device 204 then pulls the SOAP envelope from application server 206 by using the key to request the SOAP envelope from web application server process 214. Once the SOAP envelope is pulled from web application server process 214, the SOAP envelope is decoded, and one of web services 200 or 202 is then executed by handheld device 204. The result of the execution is then returned as a SOAP reply, through wireless network 228 and one or more of GSM carriers 222, 224, and 226, to web application server process 214.

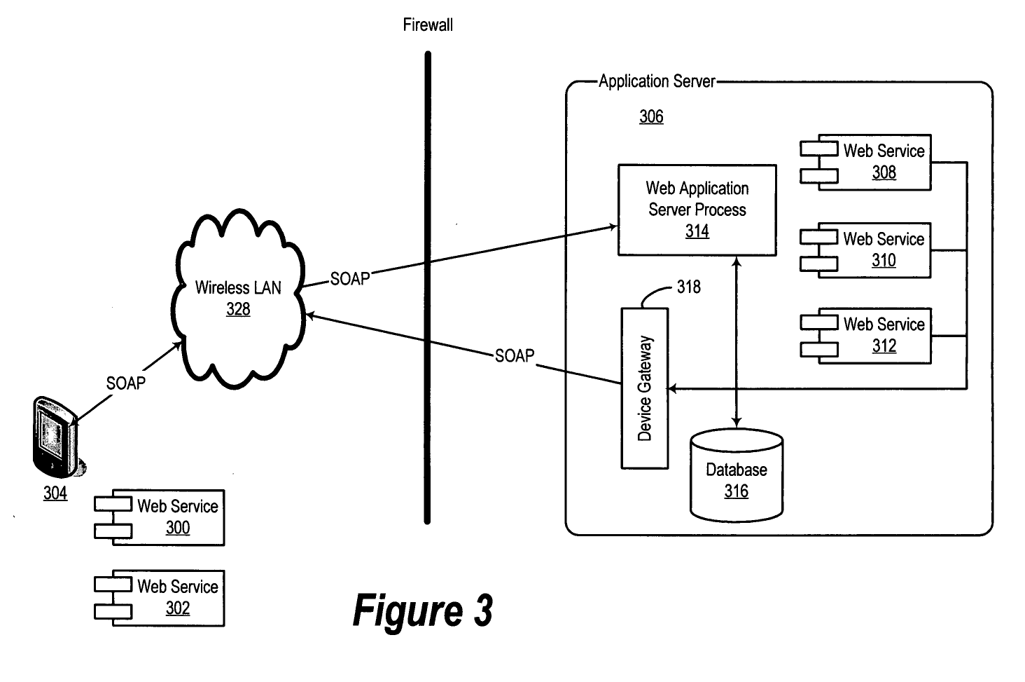

FIG. 3 is a diagram illustrating the operation of a preferred embodiment of the present invention in which web services (e.g., web services 300 and 302) residing on a mobile handheld computing/communications device 304 in a wireless local area network (WLAN) are invoked by an application server 306. WLAN systems are essentially the wireless equivalent of conventional local area network infrastructures, such as Ethernet. The most commonly employed WLAN standards in use at present follow specifications promulgated by the Institute for Electrical and Electronics Engineers (IEEE), the IEEE 802.11 standards (which, as of this writing, include 802.11a, 802.11b, and 802.11g standards). Most WLAN systems support the TCP/IP (Transmission Control Protocol/Internet Protocol) suite of network protocols, which form the foundation for the Internet. Each host computer in the WLAN receives a numerical IP (Internet Protocol) address, just as in a wired network, and a single host may also support a plurality of distinct connections by defining port numbers under the (TCP) Transmission Control Protocol standard.

When one of web services 308, 310, and 312 needs to invoke a remote web'service (such as web service 300) on handheld device 304, the invoking web service generates a request in a web services protocol (typically a SOAP envelope) to execute the remote web service. Device gateway 318 transmits the SOAP envelope over a TCP/IP connection over wireless LAN 328 to handheld device 304 on a designated TCP port.

Handheld device 304, having received the SOAP envelope on the designated TCP port, recognizes that what was received on that port was a SOAP envelope. Although in the ideal case, the fact that data is received on the designated port would in and of itself imply that the received data is a SOAP envelope, a preferred embodiment of the present invention further verifies that the received data is indeed a SOAP envelope; this prevents against spurious or invalid data being erroneously identified as a SOAP envelope. Having verified that what was received was a SOAP envelope, handheld device 304 decodes the SOAP and executes one of web services 300 or 302. The result of the execution is then returned as a SOAP reply over TCP/IP, through wireless LAN 328 to web application server process 314.

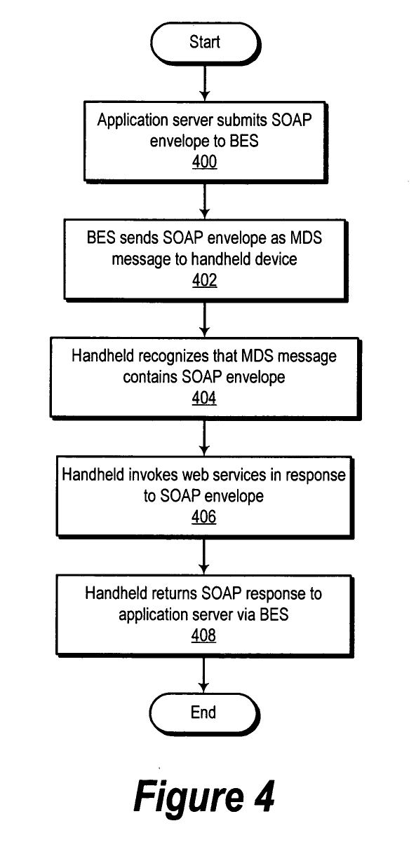

FIG. 4 is a flowchart representation of a process of invoking web services on a handheld device using Mobile Data Service (MDS) in accordance with a preferred embodiment of the present invention. An application server submits a SOAP envelope to a Blackberry Enterprise Server (BES) (block 400). The BES sends the SOAP envelope as an MDS text or e-mail message to the handheld device (block 402). The handheld device recognizes that the received MDS message contains a soap envelope (block 404). In response to this recognition, the handheld device decodes the SOAP envelope and invokes the desired web service (block 406). Finally, the handheld device returns a SOAP reply to the application server via the BES (block 408).

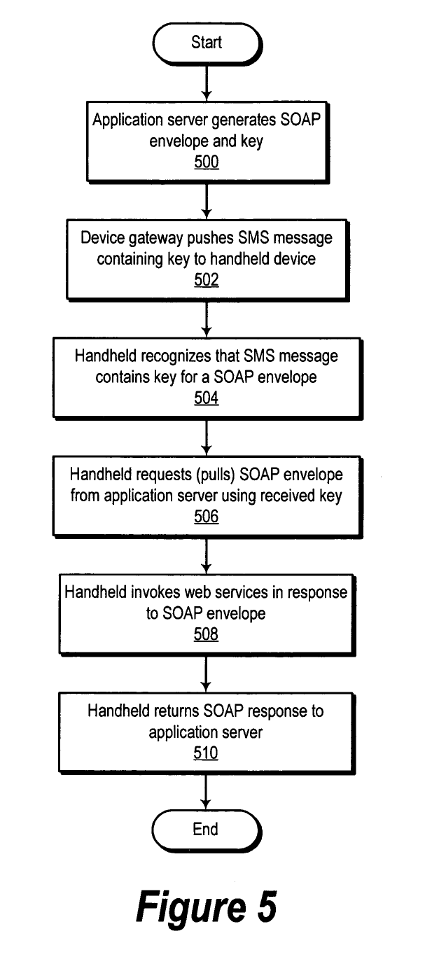

FIG. 5 is a flowchart representation of a process of invoking web services on a handheld device using the Short Message Service (SMS) of GSM (Global System for Mobile Communications) in accordance with a preferred embodiment of the present invention. An application server generates a SOAP envelope and corresponding key (block 500). The key is then sent as an SMS message to the handheld device (block 502). The handheld device recognizes that the received SMS message contains a key (block 504). In response to this recognition, the handheld device pulls the SOAP envelope from the application server by using the key to specify the desired envelope (block 506). The SOAP envelope is decoded and the desired web service is executed by the handheld device (block 508). Finally, the handheld device returns a SOAP reply to the application server (block 510).

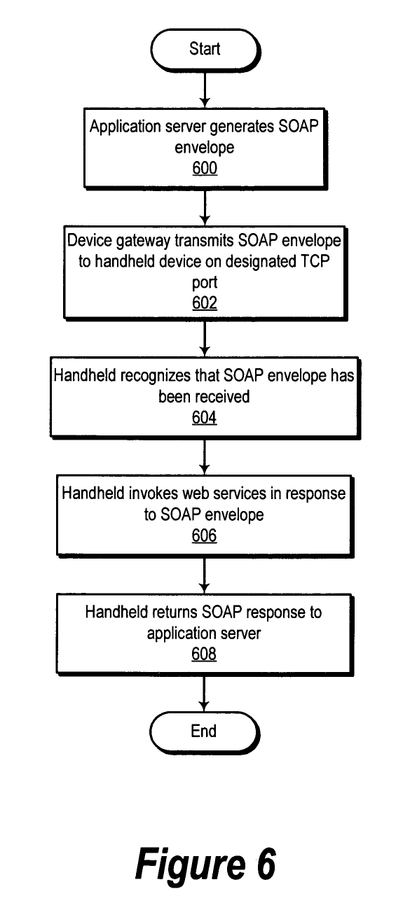

FIG. 6 is a flowchart representation of a process of invoking web services on a handheld device connected to a wireless LAN (WLAN), such as an IEEE 802.11 wireless network, in accordance with a preferred embodiment of the present invention. An application server generates a SOAP envelope (block 600). The SOAP envelope is then transmitted on a to the handheld device designated TCP port (block 602). The handheld device then recognizes that the received transmission contains a SOAP envelope (block 604). In response to this recognition, the SOAP envelope is decoded and the desired web service is executed by the handheld device (block 606). Finally, the handheld device returns a SOAP reply to the application server over a TCP/IP connection(block 610).

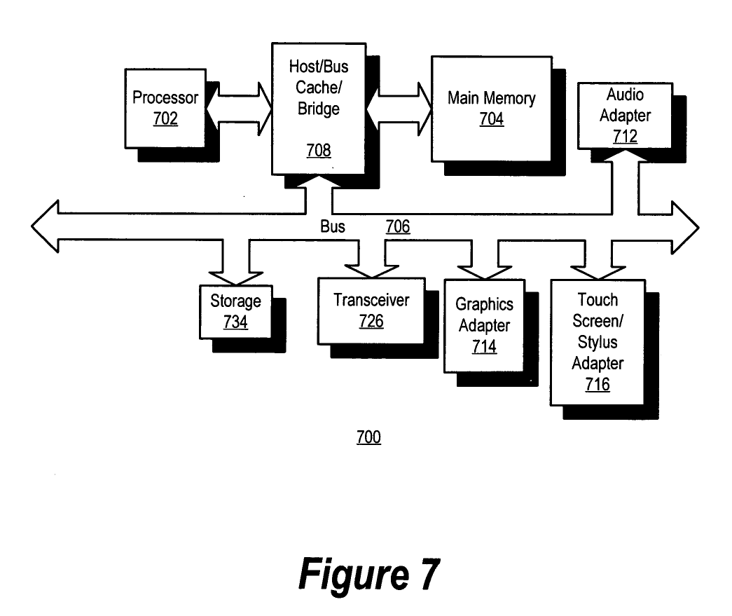

Turning now to FIG. 7, a block diagram of a personal digital assistant (PDA) is shown in accordance with a preferred embodiment of the present invention. PDA 700 is an example of a mobile computing device in which code or instructions implementing the processes of the present invention may be located. PDA 700 includes a bus 702 to which processor 704 and main memory 706 are connected to bus 702 by host/bus cache/bridge 708. Audio adapter 710 allows for sound to be presented to the user in PDA 700. Touch screen/stylus adapter 712 allows for presentation of a graphical user interface to the user as well as providing an interface for the user to input data and commands. Information such as calendars, address books, and electronic mail may be stored within storage 714. Additionally, instructions for programs, such as a mail program, may be stored within storage 714. Storage 714 may take various forms, such as a random access memory, a read-only memory, or a flash memory. The memory may be built into PDA 700 or take the form of a removable memory, such as a flash card or a memory stick.

The operating system may be, for example, a commercially available operating system such as Windows CE™, which is available from Microsoft Corporation. Instructions for the operating system and applications or programs located on storage devices, such as storage 714, may be loaded into main memory 706 for execution by processor 704.

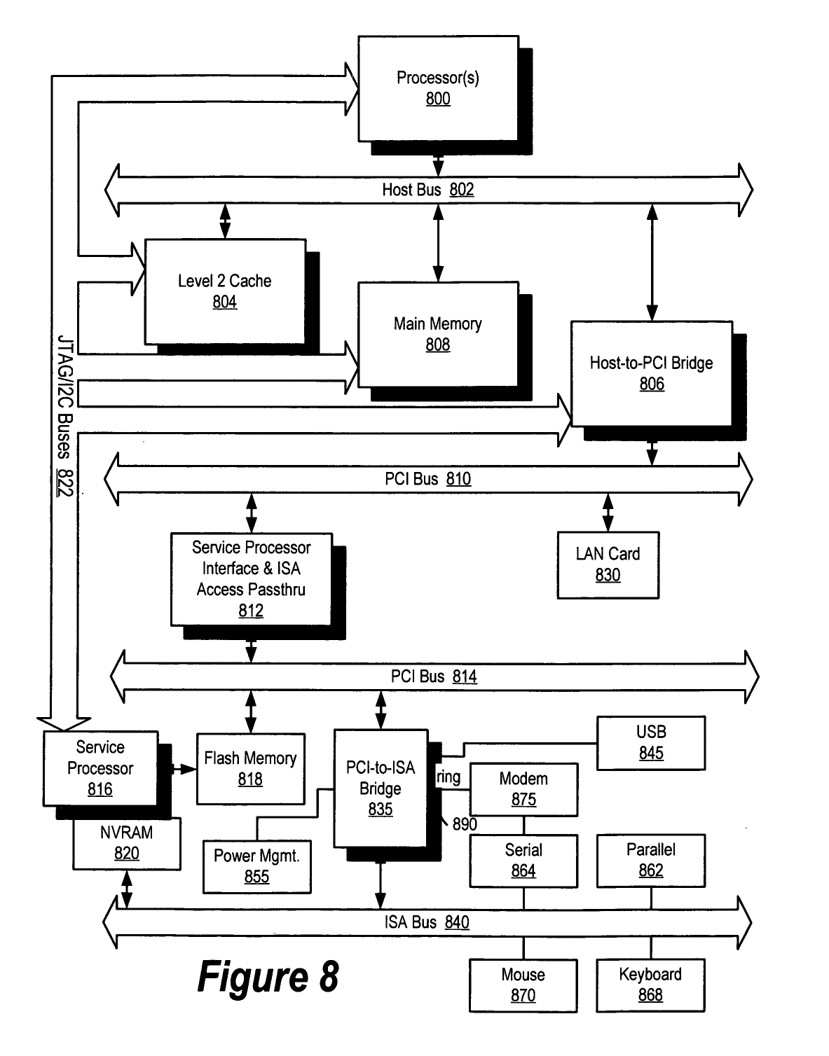

FIG. 8 illustrates information handling system 801 which is a simplified example of a computer system/server capable of performing the computing operations described herein with respect to a preferred embodiment of the present invention. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provides an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and I2C buses 822 for communication with processor(s) 800 during initialization steps. JTAG/I2C buses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the processes described herein, this computer system is simply one example of a computer system. Those skilled in the art will appreciate that many other computer system designs are capable of performing the processes described herein.

One of the preferred implementations of the invention is a software application, namely, a set of instructions (program code) or other functional descriptive material in a code module that may, for example, be resident in the random access memory of a computer. Until required by the computer, the functional descriptive material may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting examples, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method comprising:
transmitting a text message to a mobile communications device, wherein the text message contains a message identifier associated with a web service protocol message;
receiving a request from the mobile communications device, wherein the request identifies the web service protocol message; and
in response to receiving the request, transmitting the web service protocol message to the mobile communications device.

2. The method of claim 1, wherein the text message is transmitted through Short Message Service (SMS).

3. The method of claim 1, wherein the web service protocol message specifies a remote procedure call.

4. The method of claim 3, wherein the remote procedure call is specified according to Simple Object Access Protocol (SOAP).

5. The method of claim 1, wherein the mobile communications device is a personal digital assistant (PDA).

6. The method of claim 1, wherein the mobile communications device is a mobile telephone.

7. The method of claim 1, wherein the text message is transmitted over a wireless link.

8. A computer-implemented method comprising:
transmitting a text message to a mobile communications device, wherein the text message contains a request in a web service protocol; and
receiving a reply text message from the mobile communications device, wherein the reply text message contains a reply in the web service protocol.

9. The method of claim 8, wherein the text message and the reply text message are transmitted as electronic mail.

10. The method of claim 8, wherein the web service protocol is Simple Object Access Protocol (SOAP).

11. The method of claim 8, wherein the mobile communications device is a portable digital assistant (PDA).

12. The method of claim 8, wherein the mobile communications device is a mobile telephone.

13. A computer-implemented method comprising:
receiving, at a mobile communications device, a text message;
determining, from contents of the text message, that the text message identifies a web service protocol message;
in response to a determination that the text message identifies a web service protocol message, retrieving, from a server, the web service protocol message; and
executing a web service application in accordance with the retrieved web service protocol message.

14. The method of claim 13, wherein the text message and the reply text message are transmitted as electronic mail.

15. The method of claim 13, wherein the text message is received as a Short Message Service (SMS) message.

16. The method of claim 13, wherein the web service protocol is Simple Object Access Protocol (SOAP).

17. The method of claim 13, wherein the mobile communications device is a portable digital assistant (PDA).

18. The method of claim 13, wherein the mobile communications device is a mobile telephone.

19. A computer-implemented method comprising:
receiving, at a mobile communications device, a data transmission on a designated port;
recognizing, from the fact that the transmission was received on the designated port, that the transmission includes a web service protocol message; and
executing a web service application in accordance with the web service protocol message.

20. The method of claim 19, wherein the mobile communications device is a portable digital assistant (PDA).

21. The method of claim 19, wherein the mobile communications device is a mobile telephone.

22. The method of claim 19, wherein the web service protocol is Simple Object Access Protocol (SOAP).

23. A computer-implemented method comprising:
receiving a Short Message Service (SMS) message;
in response to a determination that the Short Message Service message contains a key corresponding to a SOAP envelope, requesting the SOAP envelope from a remote server using the key;
executing a web service application in accordance with the SOAP envelope; and
returning a result to the remote server.

24. A computer program product in a computer-readable medium comprising functional descriptive material that, when executed by a computer, causes the computer to perform actions that include:
transmitting a text message to a mobile communications device, wherein the text message contains a message identifier associated with a web service protocol message;
receiving a request from the mobile communications device, wherein the request identifies the web service protocol message; and
in response to receiving the request, transmitting the web service protocol message to the mobile communications device.

25. The computer program product of claim 24, wherein the text message is transmitted through Short Message Service (SMS).

26. The computer program product of claim 24, wherein the web service protocol message specifies a remote procedure call.

27. A computer program product in a computer-readable medium comprising functional descriptive material that, when executed by a computer, causes the computer to perform actions that include:
receiving, at a mobile communications device, a text message;
determining, from contents of the text message, that the text message identifies a web service protocol message;
in response to a determination that the text message identifies a web service protocol message, retrieving, from a server, the web service protocol message; and
executing a web service application in accordance with the retrieved web service protocol message.

28. A computer program product in a computer-readable medium comprising functional descriptive material that, when executed by a computer, causes the computer to perform actions that include:
receiving, at a mobile communications device, a data transmission on a designated port;
recognizing, from the fact that the transmission was received on the designated port, that the transmission includes a web service protocol message; and
executing a web service application in accordance with the web service protocol message.

29. A mobile communications device comprising:
one or more processors;
a memory accessible by the processors;
a wireless transceiver accessible by the processors; and
a set of instructions executed by the processors, wherein the set of instructions directs the processors to perform actions that include:
receiving, at a mobile communications device, a text message;
determining, from contents of the text message, that the text message identifies a web service protocol message;
in response to a determination that the text message identifies a web service protocol message, retrieving, from a server, the web service protocol message; and
executing a web service application in accordance with the retrieved web service protocol message.

30. A mobile communications device comprising:
one or more processors;
a memory accessible by the processors;
a wireless transceiver accessible by the processors; and
a set of instructions executed by the processors, wherein the set of instructions directs the processors to perform actions that include:
receiving, at a mobile communications device, a data transmission on a designated port;
recognizing, from the fact that the transmission was received on the designated port, that the transmission includes a web service protocol message; and
executing a web service application in accordance with the web service protocol message.
